(19) United States
(12) Patent Application Publication
(10) Pub. No.: US 2017/0302558 A1
(43) Pub. Date: Oct. 19, 2017

(54) MEASURING APPARATUS, MEASURING SYSTEM, MEASURING METHOD, AND RECORDING MEDIUM IN WHICH PROGRAM IS RECORDED

(71) Applicant: NEC Corporation, Minato-ku, Tokyo (JP)

(72) Inventor: Yoshikazu WATANABE, Tokyo (JP)

(73) Assignee: NEC Corporation, Minato-ku, Tokyo (JP)

(21) Appl. No.: 15/512,899

(22) PCT Filed: Oct. 5, 2015
(86) PCT No.: PCT/JP2015/005053

§ 371 Date: Mar. 21, 2017

(30) Foreign Application Priority Data
Oct. 7, 2014 (JP) 2014-206486

(51) Int. Cl. H04L 12/26; H04L 29/08

(52) U.S. Cl. CPC H04L 43/16; H04L 43/08; H04L 67/2842

(57) ABSTRACT

A measuring apparatus includes, a control means that measures a packet processing time of a communication processing means that performs packet processing of a communication flow with use of a cache memory for a plurality of communication flows, and calculates, from a measurement result, a packet processing time during which no cache miss occurs and a processing delay time due to a cache miss.

### TECHNICAL FIELD

The present invention relates to a measuring apparatus, a measuring system, a measuring method, and a program, and more particularly to a measuring apparatus, a measuring system, a measuring method, and a program for measuring an influence on communication processing due to a cache miss.

### BACKGROUND ART

An Ethernet (registered trademark) switch or router executes a packet processing function of transferring or discarding a packet according to a predetermined rule, in other words, a network switch function. A packet processing function may be implemented by a software component operated on a dedicated processor or a general-purpose processor.

When a device for executing packet processing receives and processes a packet, generally, the following processings are executed:

1: Receiving a packet from a communication interface;

2: Specifying a communication flow to which a packet belongs;

3: Referring to information necessary for processing the flow; and

4: Processing the packet based on the information.

When these processings are executed by a device having a hierarchical memory including a processor and a cache, a required time greatly differs depending on whether or not a memory access generated when referring to information in processing 3 hits a cache.

When a cache miss occurs when a processor sequentially executes the aforementioned processings 1 to 3, packet processing by the processor is temporarily stopped. As a result, a time required for the overall packet processing may increase, and packet processing performance may be lowered.

PTL 1 discloses a technique for reducing a cache miss as described above, and improving and stabilizing average processing performance. A microprocessor of PTL 1 reduces a cache miss using a pipeline processing mechanism for packet processing. The microprocessor has four buffer memories for accommodating received packets, and concurrently executes the following processings for each buffer memory:

Receiving a packet (equivalent of processing 1);

Prefetching correlated data (equivalent of processing 2 and 3);

Processing a packet (equivalent of processing 4); and

Outputting a packet (equivalent of processing 4).

The microprocessor of PTL 1 performs prefetching with respect to memory data to be referred to in processing 2, and loads the data into a cache before referring to the data. Further, the microprocessor performs another packet processing during a time when the data is loaded into the cache. In this way, the microprocessor reduces a cache miss.

PTL 2 discloses a communication system which implements a packet processing function by a software component.

### CITATION LIST

### Patent Literature

[PTL 1] Japanese Patent Publication No. 3372873

[PTL 2] International Publication WO 2012/128282

### SUMMARY OF INVENTION

### Technical Problem

The microprocessor disclosed in PTL 1 requires a special hardware component, for instance, a prefetch control unit and a buffer memory state control unit. Performing packet processing by a processor provided with the special hardware component may increase a device cost.

Further, when a packet processing function is implemented by a software component operated on a general-purpose processor, it is not possible to add the special hardware component to the processor.

In order to obtain the same advantageous effects as disclosed in PTL 1 regarding a packet processing function without using a special hardware component, it is necessary to optimize the packet processing logic as follows:

In packet processing, a processor prefetches memory data regarding a memory data access, which may be a factor of performance deterioration; and

During prefetch processing of the memory data, the processor performs another packet processing (or processing that does not rely on the memory data among processings relating to a currently processed packet).

For instance, the following measurement values are necessary for optimizing the packet processing logic. How to measure these values is a task:

A data access delay time when a cache miss occurs; and

A time required for executing packet processing when a cache miss does not occur.

It is needless to say that these measurement values may be used for another purpose, for instance, for determining a speed or a capacity of a cache memory. An object of the present invention is to provide a measuring apparatus, a measuring system, a measuring method, and a program for obtaining the aforementioned two measurement values.

### Solution to Problem

One aspect of a measuring apparatus includes, a control means that measures a packet processing time of a communication processing means that performs packet processing of a communication flow with use of a cache memory for a plurality of communication flows, and calculates, from a measurement result, a packet processing time during which no cache miss occurs and a processing delay time due to a cache miss.

One aspect of a measuring method includes, measuring a packet processing time of communication processing means that performs packet processing of a communication flow with use of a cache memory for a plurality of communication flows, and calculating, from a measurement result, the packet processing time during which no cache miss occurs and a processing delay time due to a cache miss.

One aspect of a recording medium recording a program for causing a computer to execute measuring process. The measuring process includes, measuring a packet processing time of communication processing means that performs packet processing of a communication flow with use of a cache memory for a plurality of communication flows, and calculating, from a measurement result, a packet processing time during which no cache miss occurs and a processing delay time due to a cache miss.

### Advantageous Effects of Invention

The measuring apparatus according to the present invention is advantageous in obtaining a data access delay time when a cache miss occurs, and a time required for executing packet processing when a cache miss does not occur.

### BRIEF DESCRIPTION OF DRAWINGS

FIG. 1 is an explanatory diagram illustrating an example of a configuration of a measuring system 60 according to a first example embodiment;

FIG. 2 is a block diagram illustrating a configuration example of a measuring apparatus 1;

FIG. 3 is a block diagram illustrating a configuration example of a load generating device 2;

FIG. 4 is a block diagram illustrating a detailed configuration example of the measuring apparatus 1;

FIG. 5 is a flowchart illustrating an operation example of a communication processing unit 20;

FIG. 6 is a flowchart illustrating an operation example of a measurement control unit 12;

FIG. 7 is a flowchart illustrating an operation example of a load generating unit 40;

FIG. 8 is a flowchart (part 1) illustrating an operation example of an optimization control unit 11;

FIG. 9 is a flowchart (part 2) illustrating an operation example of the optimization control unit 11;

FIG. 10 is a graph illustrating an example of a measurement result on a time required for packet processing by the communication control unit 20;

FIG. 11 is a graph illustrating an example of a residual sum of squares to be calculated by the optimization control unit 11;

FIG. 12 is a table illustrating an example of measurement output values to be output from the measuring apparatus 1;

FIG. 13 is a schematic diagram illustrating a time sequence example of packet processing for describing processing optimization of the communication processing unit 20, which can be performed with use of measurement output values to be output from the measuring apparatus 1;

FIG. 14 is a flowchart (part 1) illustrating an operation example of the communication processing unit 20 after optimization;

FIG. 15A is a flowchart (part 2-1) illustrating an operation example of the communication processing unit 20 after optimization;

FIG. 15B is a flowchart (part 2-2) illustrating an operation example of the communication processing unit 20 after optimization; and

FIG. 16 is an explanatory diagram illustrating an example of a configuration of a measuring apparatus 1 according to a second example embodiment.

### DESCRIPTION OF EMBODIMENTS

### First Example Embodiment

[Outline]

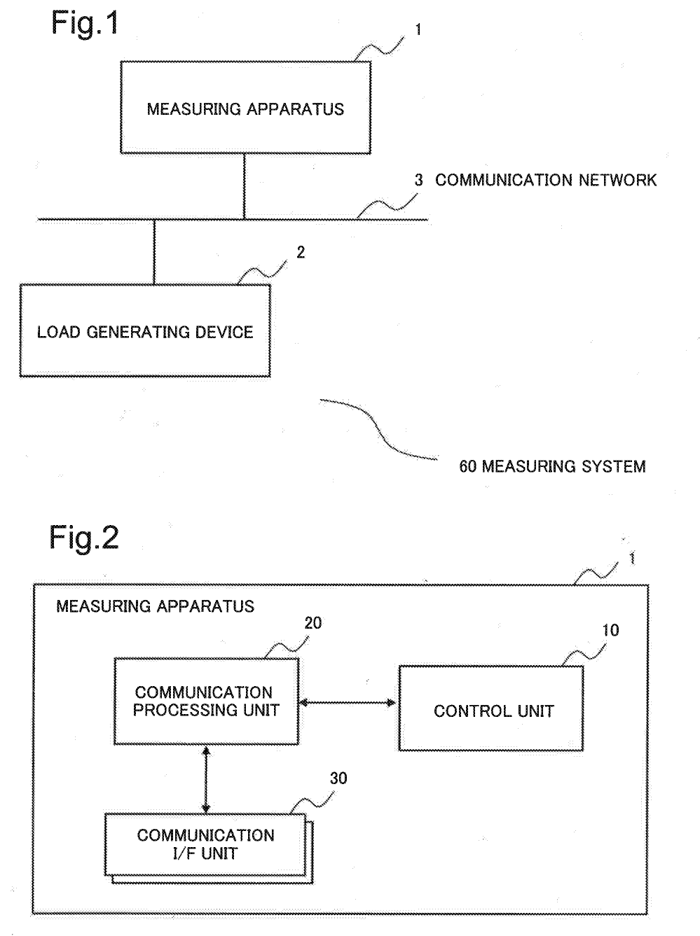

FIG. 1 is an explanatory diagram illustrating an example of a configuration of a measuring system 60 according to the example embodiment. The measuring system 60 exemplified in FIG. 1 includes a measuring apparatus 1, a load generating device 2 and a communication network 3.

The measuring apparatus 1 is an apparatus provided with a hierarchical memory including a general-purpose or dedicated processor, and a cache (all of which are not illustrated). The measuring apparatus 1 executes packet processing which implements a network switch function on the processor, and measures a processing time during the absence of a cache miss, and a processing delay time due to a cache miss (hereinafter, these values may also be referred to as measurement output values).

These measurement output values are usable, for instance, for optimization of packet processing as described above, and for determination of a speed and a capacity of a cache memory.

For instance, the measuring apparatus 1 is implemented by a computer and a software packet processing function. The measuring apparatus 1 may be a dedicated apparatus in which a dedicated processor equipped with a dedicated logic circuit is loaded.

The load generating device 2 is a device which generates a communication load required for the measuring apparatus 1. For instance, the load generating device 2 is implemented by a computer including a hierarchical memory including a processor and a cache, and a software packet generating function. The load generating device 2 may be a dedicated device equipped with a dedicated logic circuit.

The communication network 3 is a communication path which couples the measuring apparatus 1 to the load generating device 2. For instance, the communication network 3 is implemented by an Ethernet (registered trademark), LAN (Local Area Network).

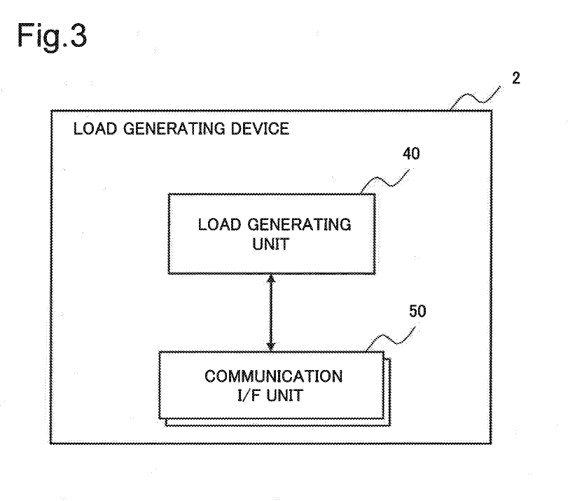

FIG. 2 is a block diagram illustrating a configuration example of the measuring apparatus 1. The measuring apparatus 1 exemplified in FIG. 2 includes a control unit 10, a communication processing unit 20, and a communication I/F (Interface) unit 30. The number of communication I/F units 30 may be one or more.

The control unit 10 performs control for measurement relating to the communication processing unit 20.

The communication processing unit 20 is operated as a network switch, receives a packet received by the communication I/F unit 30, and executes packet processing. The communication processing unit 20 specifies a flow to which a received packet belongs, refers to information relating to the flow, and determines a method for processing the packet for processing.

The communication I/F unit 30 is an interface for coupling the measuring apparatus 1 to the communication network 3, and performs communication according to a protocol to be used in the communication network 3.

The control unit 10, the communication processing unit 20, and the communication I/F unit 30 are constituted by a logic circuit. The control unit 10, the communication processing unit 20, or the communication I/F unit 30 may be implemented by a software component, which is stored in a memory of the measuring apparatus 1 as a computer, and is executed on a processor.

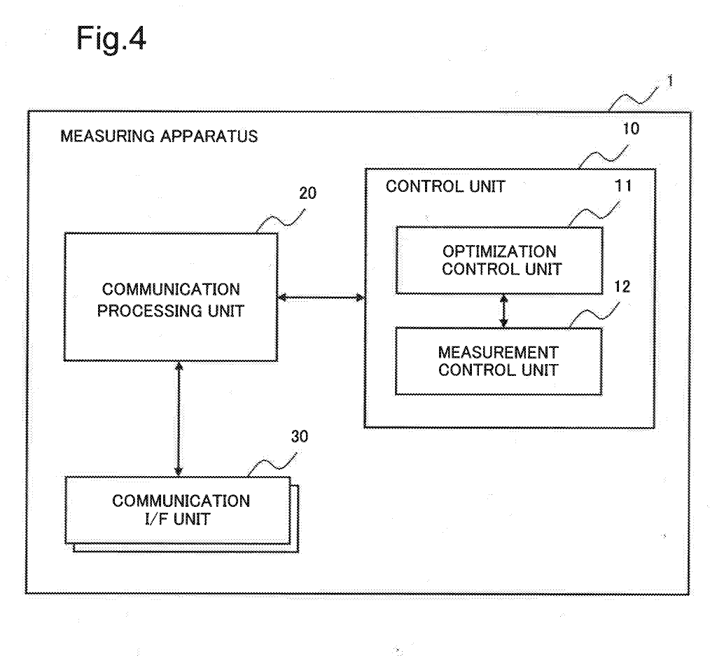

FIG. 3 is a block diagram illustrating a configuration example of the load generating device 2. The load generating device 2 exemplified in FIG. 3 includes a load generating unit 40 and a communication I/F unit 50. The number of communication I/F units 50 may be one or more.

The load generating unit 40 generates and transmits a packet serving as a load of the communication processing unit 20 under an instruction of the control unit 10 of the measuring apparatus 1. For instance, an instruction of the control unit 10 includes a part or all of the number of flows, transmission destination information, transmission source information, a transmission rate, and a transmission pattern.

The communication I/F unit 50 is an interface for coupling the load generating device 2 to the communication network 3, and performs communication according to a protocol to be used in the communication network 3.

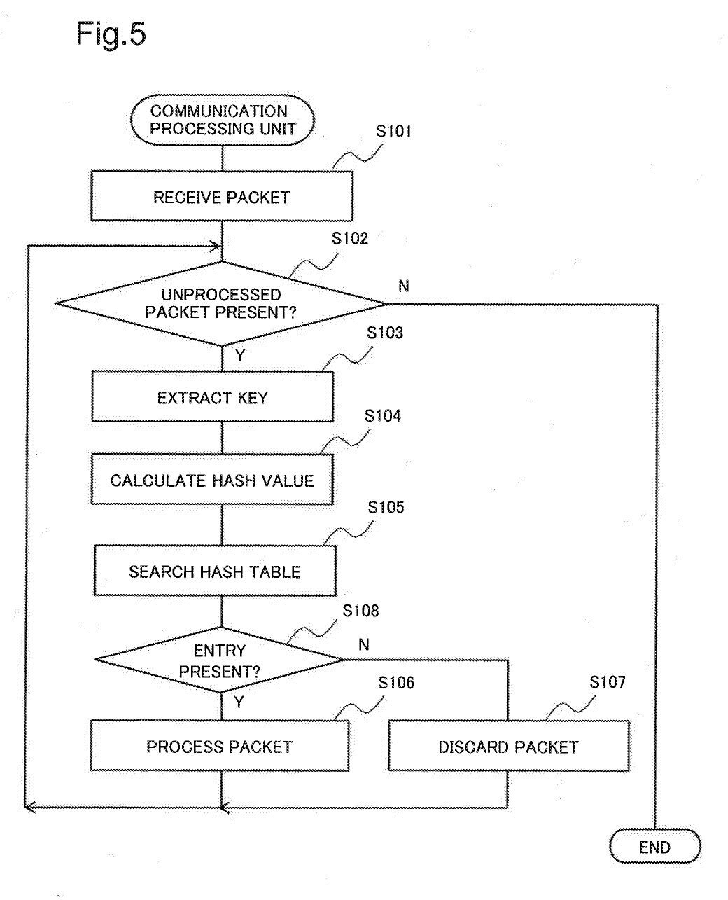

FIG. 4 is a block diagram illustrating a detailed configuration example of the measuring apparatus 1. The control unit 10 includes an optimization control unit 11 and a measurement control unit 12.

The optimization control unit 11 instructs the measurement control unit 12 to measure a time required for packet processing to be executed by the communication processing unit 20 for a plurality of times, and receives a measurement result. The optimization control unit 11 instructs the measurement control unit 12 to measure at a different number of flows for each of the measurements. The optimization control unit 11 determines the necessity of further measurement, or the number of flows when further measurement is performed based on an obtained measurement result. Further, the optimization control unit 11 determines a cache miss flow threshold, which is the number of flows threshold relating to a cache miss, which occurs during packet processing by the communication processing unit 20 based on an obtained measurement result.

A cache miss flow threshold is a threshold constituted by one or more values. A cache miss flow threshold is a value indicating the number of flows such that occurrence of a cache miss is less in packet processing for the number of flows equal to or smaller than the threshold, and a cache miss regularly occurs in packet processing for the number of flows equal to or larger than the threshold.

The capacity of a set of memory blocks (hereinafter, referred to as a working set) to be accessed by packet processing increases with an increase in the number of flows. Further, when the working set capacity exceeds the cache memory capacity, a cache miss occurs. A cache miss flow threshold is a value which approximates the number of flows when the working set capacity exceeds the cache memory capacity.

The optimization control unit 11 determines a cache miss flow threshold from the aforementioned measurement result. Further, the optimization control unit 11 determines the following measurement output values relating to the communication processing unit 20 from a measurement result and a determined cache miss flow threshold:

A data access delay time when a cache miss occurs; and

A time required for executing each sub processing constituting packet processing when a cache miss does not occur.

Note that a cache miss in this example indicates a cache miss which regularly occurs due to an increase in the working set capacity due to an increase in the number of flows (the same definition is applied to description hereinafter). Regarding description “when a cache miss does not occur”, occurrence of a cache miss is not always zero. For instance, even when the working set capacity is sufficiently smaller than the cache memory capacity, a cache miss may occur due to a change in a memory block group included in a working set. A data access delay time to be measured by the measuring apparatus 1 is not due to a cache miss as described above, but is due to a cache miss which regularly occurs due to an increase in the working set capacity.

The measurement control unit 12 receives the number of flows as an input, controls the communication processing unit 20 and the load generating unit 40, and measures a packet processing time when the communication processing unit 20 performs communication for a designated number of flows. The measurement control unit 12 may control the load generating unit 40 through the communication network 3 or through an unillustrated control network.

For instance, the communication processing unit 20 in the example embodiment processes an IP (Internet Protocol) packet. The communication processing unit 20 specifies a flow with use of a transmission source IP address, a transmission destination IP address, an upper layer protocol number, a transmission destination port number, and a transmission source port number (hereinafter, also referred to as a 5-tuple) included in a packet header. Specifically, the communication processing unit 20 determines that a packet group whose 5-tuple value (hereinafter, also referred to as a key) is the same as a packet group belonging to a same flow.

The communication processing unit 20 in the example embodiment uses a flow entry as a processing rule relating to a flow. A flow entry is identified/specified by a 5-tuple value, and includes a method for processing a packet belonging to a flow associated with the 5-tuple.

A method for processing a packet may be outputting and discarding a packet from a specific communication I/F unit 30, notifying a packet to an unillustrated module/device inside or outside of the measuring apparatus 1, or storing a packet in an unillustrated storage device, for instance.

The communication processing unit 20 stores a flow table including a flow entry. The communication processing unit 20 operates the content of a flow table. Specifically, the communication processing unit 20 provides an interface for adding/referring/updating/deleting a flow entry to the control unit 10. For instance, the communication processing unit 20 stores a flow entry with use of a hash table on a memory of the measuring apparatus 1. For instance, a hash table to be used by the communication processing unit 20 may be an open addressing hash table.

The communication processing unit 20 receives and processes a packet received by the communication I/F unit 30. The communication processing unit 20 executes the following processings with respect to a received packet:

A: Acquiring a 5-tuple value of the packet;

B: Searching a flow entry associated with the packet; and

C: Processing the packet according to a processing method included in an acquired flow entry.

Note that in processing B, when a flow entry associated with a received packet is not retrieved, the communication processing unit 20 may discard the packet, or may notify an unillustrated module/device inside or outside of the measuring apparatus 1 of occurrence of the aforementioned event.

The communication processing unit 20 has a function of measuring a part or all of times required for executing the respective processings A to C. For instance, the communication processing unit 20 may measure a required time with use of a cycle number counter included in a processor of the measuring apparatus 1 or of the communication processing unit 20. For instance, the communication processing unit 20 may acquire a value from a cycle number counter immediately before processing A is started, acquire a value from the cycle number counter immediately after processing A is finished, and measure a time required for processing A or a required cycle number from a difference between the acquired values. Alternatively, the communication processing unit 20 may measure a processing time with use of a real-time timer. The communication processing unit 20 may measure a required time with a granularity finer than the processing unit of processings A to C.

[Operation]

Next, an operation of the example embodiment is described in detail referring to the drawings.

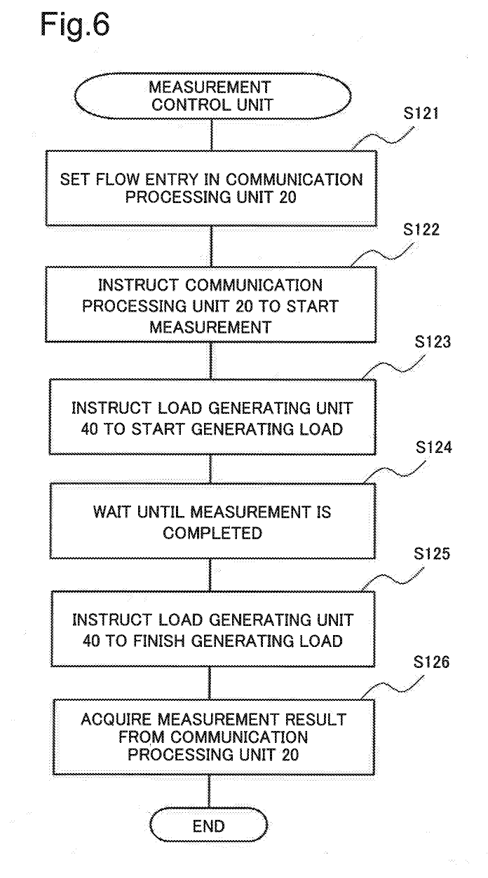

FIG. 5 is a flowchart illustrating an operation to be performed when the communication processing unit 20 receives and processes a packet from the communication I/F unit 30. The operation may be started on an event-driven basis, or may be started by a polling operation by the communication processing unit 20.

The communication processing unit 20 receives a packet from the communication I/F unit 30 (Step S101). The communication processing unit 20 confirms whether all the received packets are processed, and finishes the processing when an unprocessed packet is not present (N in Step S102).

When an unprocessed packet is present (Y in Step S102), the communication processing unit 20 starts processing a first packet, and extracts a key of the packet (Step S103). For instance, the communication processing unit 20 obtains a 5-tuple value of the packet, specifically, a transmission source IP address, a transmission destination IP address, an upper layer protocol number, a transmission destination port number, and a transmission source port number.

The communication processing unit 20 calculates a hash value regarding a key of the packet (Step S104). The communication processing unit 20 searches a hash table based on an obtained hash value, and retrieves a flow entry relating to a flow to which the packet belongs (Step S105).

When a flow entry with respect to the packet is retrieved (Y in Step S108), the communication processing unit 20 processes the packet according to a processing method designated by the flow entry (Step S106).

When a flow entry with respect to the packet is not retrieved (N in Step S108), the communication processing unit 20 discards the packet (Step S107). The communication processing unit 20 may notify generation of a packet in which an associated flow entry is not present to an unillustrated module/device inside or outside of the measuring apparatus 1, in place of discarding the packet or in addition to discarding the packet.

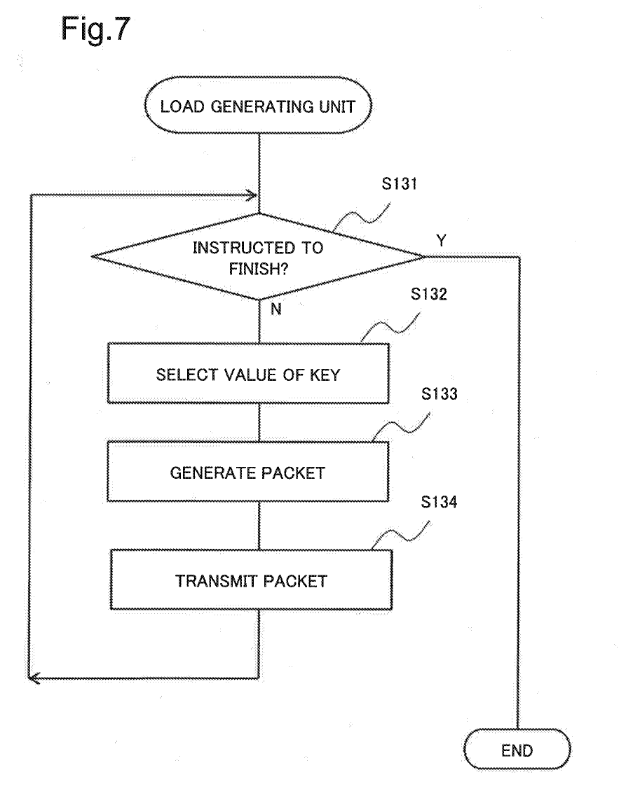

FIG. 6 is a flowchart illustrating an operation to be performed when the measurement control unit 12 measures a time required for packet processing by the communication processing unit 20. The operation is started by request of the optimization control unit 11, for instance. In starting the operation, the measurement control unit 12 receives at least the number of flows to be used for measurement as an input parameter.

The measurement control unit 12 sets a flow entry for a designated number of flows in the communication processing unit 20 (Step S121). For instance, the measurement control unit 12 may generate a key for a flow entry to be set at random as far as overlapping does not occur, or may generate a key by sequentially increasing a value (e.g. a transmission destination IP address). For instance, a method for processing a flow entry to be set may be outputting from a communication I/F unit 30 of a receiving source, or outputting and discarding from a communication I/F unit 30 of a source other than a receiving source.

The measurement control unit 12 instructs the communication processing unit 20 to start measurement of a time required for packet processing (Step S122). Note that when the communication processing unit 20 constantly performs measurement of a required time during an operation thereof, the aforementioned step may be omitted.

The measurement control unit 12 instructs the load generating unit 40 to start generating a load (Step S123). In this case, the measurement control unit 12 transfers a set of keys generated in Step S121 to the load generating unit 40 as an input parameter. Alternatively, the measurement control unit 12 and the load generating unit 40 may share an algorithm for generating a key set in advance, and the measurement control unit 12 may transfer, to the load generating unit 40, only an input parameter necessary for generating a set of same values.

The measurement control unit 12 waits until measurement is completed (Step S124). For instance, the measurement control unit 12 may judge that measurement is completed upon lapse of a predetermined fixed time. Alternatively, the measurement control unit 12 may periodically acquire, from the communication processing unit 20, the number of packets processed by the communication processing unit 20 from start of measurement, and may judge that measurement is completed when the number reaches a predetermined threshold.

The measurement control unit 12 instructs the load generating unit 40 to finish generating a load (Step S125). The measurement control unit 12 acquires a measurement result from the communication processing unit 20, and transfers the measurement result to the optimization control unit 11 (Step S126).

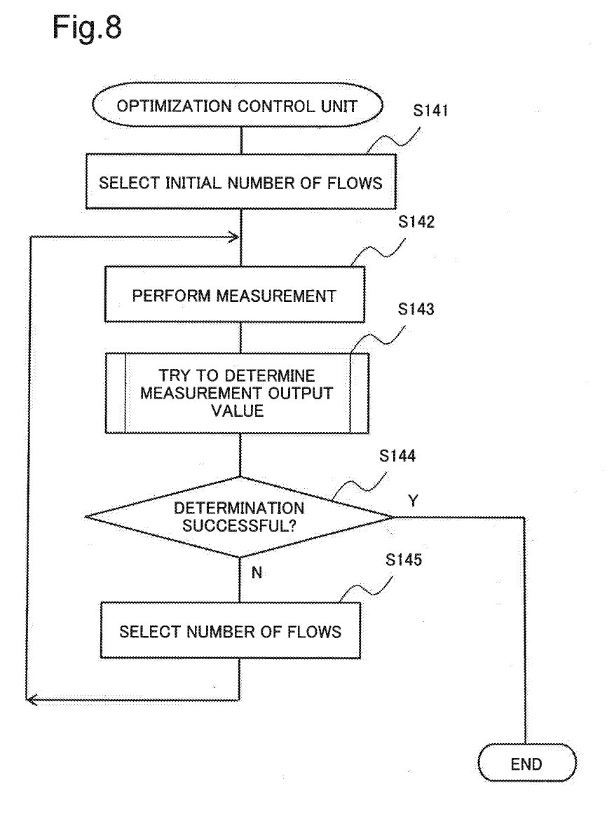

FIG. 7 is a flowchart illustrating an operation to be performed when the load generating unit 40 generates communication serving as a load of the communication processing unit 20. The operation is started by request of the measurement control unit 12, for instance. In starting the operation, the load generating unit 40 receives a set of keys to be used for a packet to be generated as an input parameter, for instance.

The load generating unit 40 confirms whether there is an instruction to finish (Step S131). When there is an instruction to finish (Y in Step S131), the load generating unit 40 finishes the operation.

When there is no instruction to finish (N in Step S131), the load generating unit 40 selects a key to be used in a packet to be transmitted next from a set of keys to be used (Step S132). The load generating unit 40 selects a value of the key in such a manner that values within the set are used uniformly as much as possible. For instance, the load generating unit 40 may arrange elements within the set in a predetermined order, and may sequentially select a value of the key according to the order. In this case, the load generating unit 40 uses the values from the first value again when the value reaches the last one in the order. Further, the load generating unit 40 may select a value of the key to be used at random from the set.

The load generating unit 40 generates a packet including a key selected in Step S132 (Step S133). The load generating unit 40 may generate a value of a packet field at random regarding the packet field other than a 5-tuple, or may use a predetermined given value. Further, the load generating unit 40 may use an address to be used in the communication I/F unit 30 or in the communication I/F unit 50 relating to an address field. The load generating unit 40 may acquire these addresses as a part of an input parameter from an OS (Operating System, not illustrated) or from a request source.

The load generating unit 40 transmits a packet generated in Step S133 from the communication I/F unit 50 (Step S134). The load generating unit 40 continues this operation until receiving an instruction to finish (Y in Step S131).

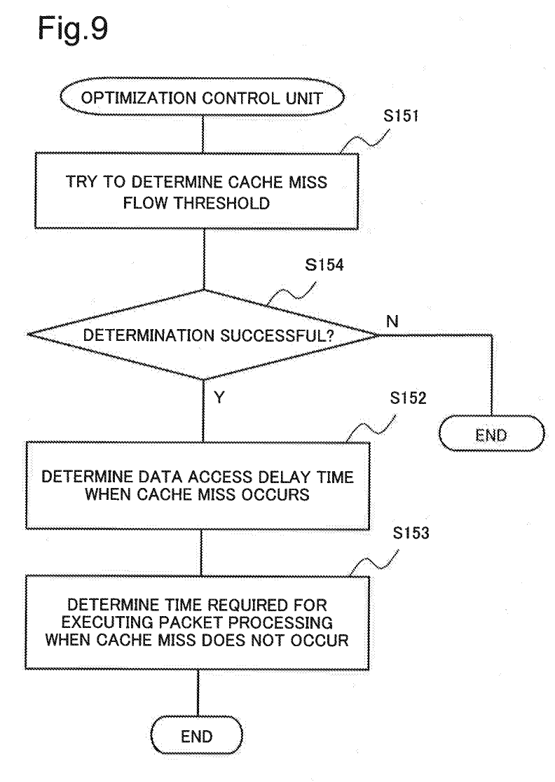

FIG. 8 is a flowchart illustrating an operation to be performed when the optimization control unit 11 determines measurement output values relating to the communication processing unit 20. The operation may be started by a user, for instance.

The optimization control unit 11 selects the number of flows to be used for a first measurement (Step S141). The optimization control unit 11 may select a predetermined value, or may select a value to be given by a user when the operation is started.

The optimization control unit 11 instructs the measurement control unit 12 to measure with use of a selected number of flows as an input parameter, and receives a result of the measurement (Step S142).

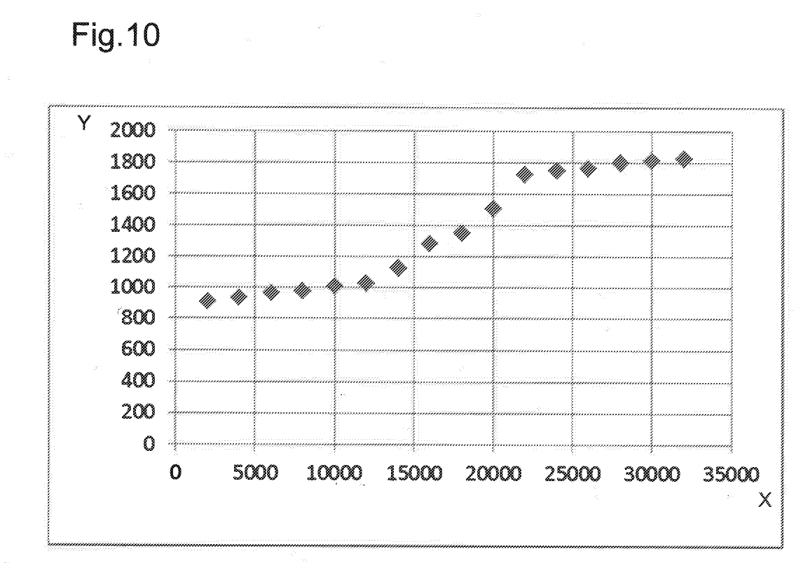

The optimization control unit 11 tries to determine measurement output values relating to the communication processing unit 20 based on measurement results collected in the operation (a measurement result in Step S126) (Step S143). The method will be described later using FIG. 9. When determination of measurement output values succeeds in Step S143 (Y in Step S144), the optimization control unit 11 finishes the processing.

When determination of measurement output values fails (N in Step S144), the optimization control unit 11 selects another number of flows, and tries again to determine measurement output values by performing next measurement (Step S145).

For instance, the optimization control unit 11 may use a value obtained by adding a predetermined value to the number of flows used for a last measurement for a next measurement. Further, when the optimization control unit 11 fails in determination of measurement output values a certain number of times, the optimization control unit 11 may change the value to be used for measurement, and may repeat the operation to be performed in determining measurement output values relating to the communication processing unit 20 from Step S141. In this case, for instance, the optimization control unit 11 may set the number of flows to be used for a first measurement in Step S141 to a half of the number of flows used in a previous operation. Further, the optimization control unit 11 may set the number of flows, which is increased in Step S145 for each measurement, to a half or two times of the number of flows used in a previous operation.

Next, there is described an example of a method for determining the following parameters as measurement output values relating to the communication processing unit 20 by the optimization control unit 11 in Step S143 referring to FIG. 9:

A data access delay time when a cache miss occurs; and

A time required for executing each sub processing constituting packet processing when a cache miss does not occur.

The optimization control unit 11 tries to determine a cache miss flow threshold (Step S151). In the following description, a cache miss flow threshold is constituted by two values, namely, the number of flows at which a cache miss starts to increase, and the number of flows at which a cache miss increase ends (is saturated).

The optimization control unit 11 determines a cache miss flow threshold using a rate of change of an error in an approximation formula, for instance. When the number of communication flows is successively increased, and a processing time per packet in packet processing by the communication processing unit 20 is measured, first of all, the working set capacity of packet processing exceeds the cache memory capacity, a cache miss starts to occur, and a processing time starts to increase. Thereafter, when the working set capacity continues to increase as the number of flows increases, a cache miss also continues to increase for a while, and a processing time per packet in packet processing also continues to increase accordingly. However, when the working set capacity further continues to increase, and a cache miss regularly occurs, an increase in the processing time per packet ends. Specifically, a rate of increase in the processing time per packet greatly changes between a point of time when a cache miss starts to occur, and a point of time when a cache miss regularly occurs. The optimization control unit 11 detects a change in the rate of increase using the fact that an error in an approximation formula increases as a change in the rate of increase increases, and detects a cache miss flow threshold.

Specifically, first of all, the optimization control unit 11 obtains an approximation formula regarding sequential measurement results of a predetermined number (hereinafter, referred to as a threshold number of the flows determination unit), and an error thereof or a statistic amount relating to an error (hereinafter, simply referred to as an error) for a plurality of flows. For instance, the optimization control unit 11 defines that a required time y with respect to x is approximated by a linear equation: y=ax+b when it is assumed that the number of flows is x, derives coefficients of an approximation formula, and calculates an error. For instance, the optimization control unit 11 may use a least-square method for the calculation.

The optimization control unit 11 may determine a cache miss flow threshold as a flow number at which an error locally becomes a peak. In this case, the optimization control unit 11 may determine a peak by scanning a numerical value row of errors, or may determine whether or not there is a peak by comparing a predetermined given threshold and an error.

For instance, when it is not possible to detect a peak, or when the number of peaks is different from a predetermined given value, the optimization control unit 11 may determine that it is not possible to determine measurement output values from a current measurement result group (N in Step S154).

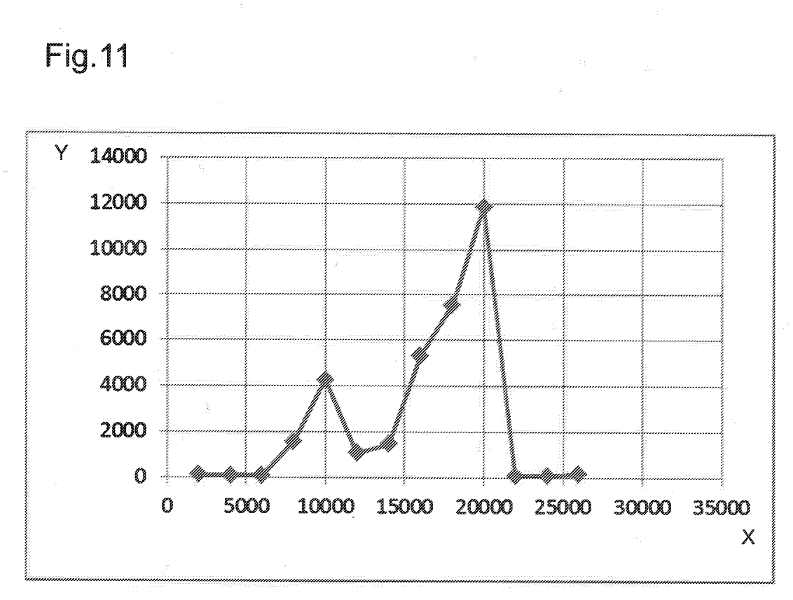

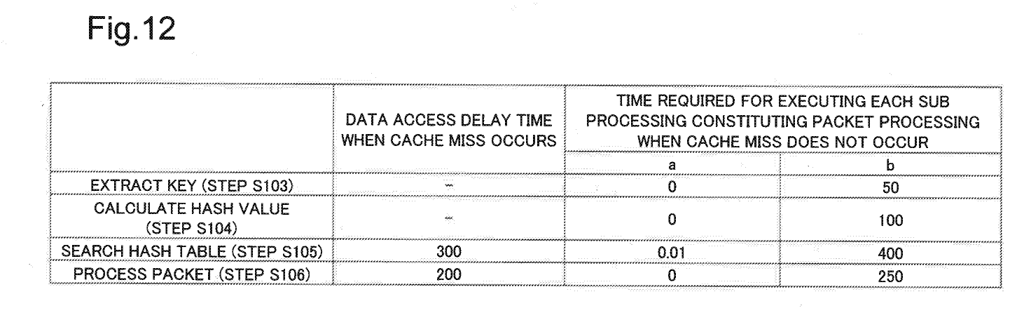

There is described an example of a method for determining a cache miss flow threshold by the optimization control unit 11 referring to FIG. 10 and FIG. 11.

FIG. 10 illustrates a measurement result on a time required for packet processing by the communication processing unit 20, for instance, an example of an average required cycle number per packet. In the graph of FIG. 10, the X-axis indicates a flow number, and the Y-axis indicates a measurement result. In this example, the optimization control unit 11 starts measurement from a case where the number of flows is 2,000, and thereafter, performs measurement until a case where the number of flows reaches 32,000 by increasing the number of flows by 2,000 each time.

In this example, there is described a case, in which the number of flows threshold determination unit is set to 4. First of all, the optimization control unit 11 derives coefficients of an approximation formula with use of a least-square method regarding measurement results for a first threshold number of the flows determination unit (e.g. flow numbers 2,000, 4,000, 6,000, and 8,000) from a measurement result, and obtains a residual sum of squares. Next, the optimization control unit 11 derives coefficients of an approximation formula regarding measurement results equivalent of a second threshold number of the flows determination unit (e.g. flow numbers 4,000, 6,000, 8,000, and 10,000) from a measurement result, and obtains a residual sum of squares. The optimization control unit 11 performs the same calculation as described above regarding a third threshold number of the flows determination unit and thereafter.

As a result of the calculation, a group of residual sums of squares as illustrated in FIG. 11 is obtained. In the graph of FIG. 11, the X-axis indicates a flow number, and the Y-axis indicates a residual sum of squares. In FIG. 11, a residual sum of squares to be obtained when coefficients of an approximation formula are derived regarding a first threshold number of the flows determination unit is plotted at a position of the number of flows 2,000. A residual sum of squares to be obtained when coefficients of an approximation formula are derived regarding a second threshold number of the flows determination unit is plotted at a position of the number of flows 4,000. A residual sum of squares to be obtained when coefficients of an approximation formula are derived regarding a third threshold number of the flows determination unit is plotted at a position of the number of flows 6,000. Thereafter, residual sums of squares are plotted as described above.

The optimization control unit 11 detects that there is a peak at a position of the number of flows 10,000 and at a position of the number of flows 20,000 by scanning a numerical value row of errors. Specifically, the optimization control unit 11 detects that a cache miss starts to occur in a flow number zone A (10,000, 12,000, 14,000, and 16,000), and that a cache miss regularly occurs in a flow number zone B (20,000, 22,000, 24,000, and 26,000) and an increase in the processing time ends.

In this case, for instance, the optimization control unit 11 determines a minimum value (10,000) in the zone A and a maximum value (26,000) in the zone B as a cache miss flow threshold. The optimization control unit 11 may determine a median (13,000) in the zone A and a median (23,000) in the zone B as a cache miss flow threshold. The optimization control unit 11 may determine an average value of a flow number group (equivalent of a threshold number of the flows determination unit) in the zone A and in the zone B as a cache miss flow threshold. Further, the optimization control unit 11 may determine a maximum value (8,000) in a zone adjacent to the zone A and whose values are smaller than those in the zone A, and a minimum value (28,000) in a zone adjacent to the zone B and whose values are larger than those in the zone B as a cache miss flow threshold.

When a cache miss flow threshold is determined (Y in Step S154), the optimization control unit 11 determines a data access delay time when a cache miss occurs (Step S152). The optimization control unit 11 sets a data access delay time when a cache miss occurs, as a difference between a time required for packet processing for a flow number equal to or larger than a larger cache miss flow threshold, and a time required for packet processing for a flow number equal to or smaller than a smaller cache miss flow threshold. In the aforementioned example, for instance, the optimization control unit 11 sets a data access delay time, as a difference between a time required for packet processing when the number of flows is equal to or larger than 26,000, and a time required for packet processing when the number of flows is equal to or smaller than 10,000.

For instance, the optimization control unit 11 may determine a data access delay time when a cache miss occurs by one or combination of the following operations:

The optimization control unit 11 derives coefficients of an approximation formula with use of a least-square method regarding each of a measurement result group for a flow number equal to or larger than a cache miss flow threshold, and a measurement result group for a flow number equal to or smaller than a cache miss flow threshold, and sets a difference between the obtained two coefficients b as a data access delay time; and

The optimization control unit 11 selects a flow number each from a flow number group, whose flow number is equal to or larger than a cache miss flow threshold, and a flow number group, whose flow number is equal to or smaller than a cache miss flow threshold from a measurement result. For instance, the optimization control unit 11 selects a value most approximate to a cache miss flow threshold. Then, the optimization control unit 11 sets a difference between measurement results regarding the number of flows as a data access delay time.

Next, the optimization control unit 11 determines a time required for executing packet processing when a cache miss does not occur (Step S153). For instance, the optimization control unit 11 derives coefficients of an approximation formula with use of a least-square method regarding a measurement result group, whose flow number is equal to or smaller than a cache miss flow threshold, and determines a time required for executing packet processing from the approximation formula and the number of flows x.

Note that the aforementioned description is made based on the premise that measurement is performed for the overall packet processing. For instance, the optimization control unit 11 is able to output measurement output values regarding each sub processing included in packet processing when the communication processing unit 20 outputs a measurement result by dividing a processing time in the unit of sub processing (e.g. each step in FIG. 5) constituting packet processing.

[Use Example of Measurement Output Values]

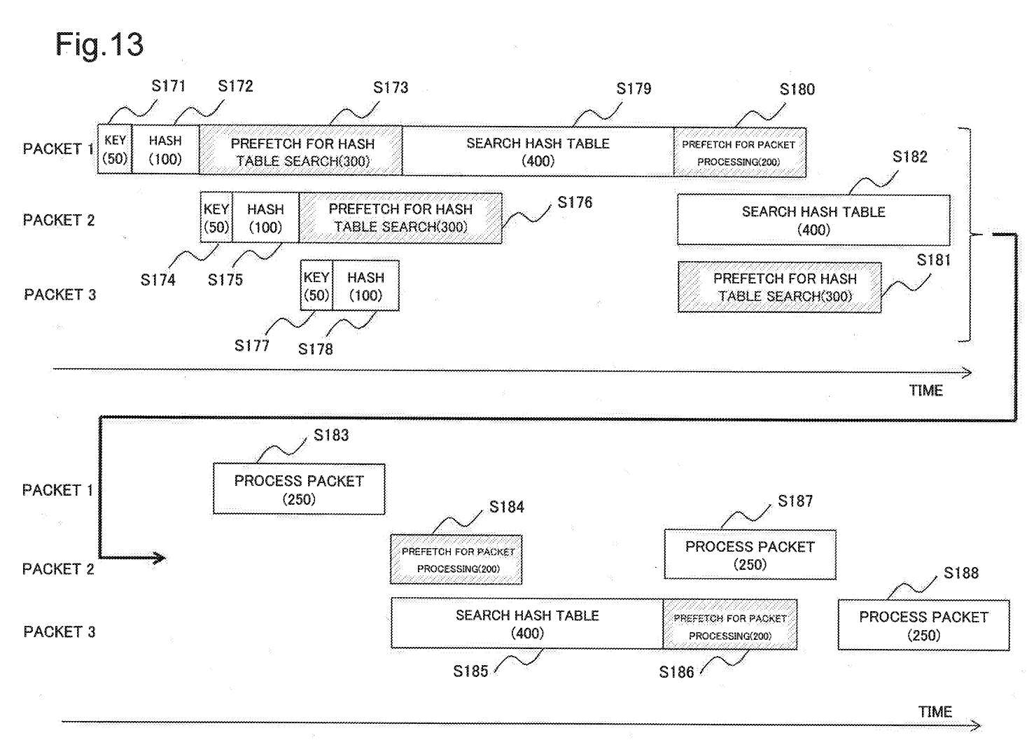

In this section, there is described a method for optimizing a packet processing function (e.g. processing to be executed by the communication processing unit 20 in the example embodiment) with use of measurement output values to be output from the measuring apparatus 1 of the example embodiment, using FIG. 12 to FIG. 14. In the following description, it is assumed that measurement output values illustrated in FIG. 12 are obtained. FIG. 12 illustrates “a data access delay time when a cache miss occurs” and “a time required for executing each sub processing constituting packet processing when a cache miss occurs” regarding Step S104 to Step S106 in FIG. 5. Note that the latter is indicated by coefficients a and b of an approximation formula on a required time.

Optimization of a packet processing function is attained by loading data necessary for packet processing into a cache memory before a processor refers to the data, and by causing the processor to process another packet during a time when the data is loaded into a cache. Optimization of a packet processing function reduces a cache miss, and improves the operating rate of a processor. Measurement output values to be output from the measuring apparatus 1 of the example embodiment are useful in design modification of the measuring apparatus 1.

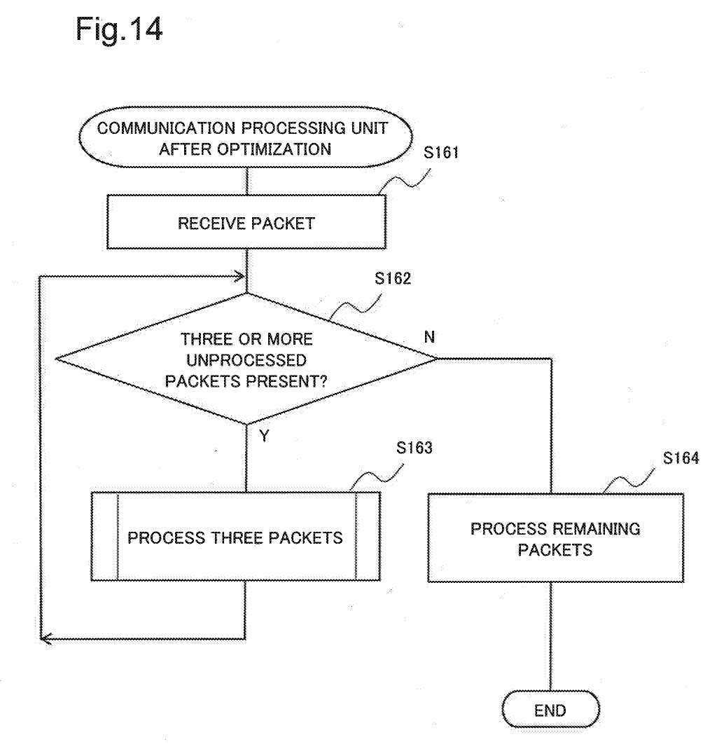

FIG. 13 illustrates a time sequence example of packet processing for describing optimization of processing of the communication processing unit 20. In the operation modification example, a processor of the communication processing unit 20 after operation modification performs processing concurrently regarding three packets. It is assumed that the three packets are a packet 1, a packet 2, and a packet 3.

In FIG. 13, a blank rectangle indicates that a processor is executing a sub processing with respect to a packet, specifically, key extraction, hash value calculation, or the like. A time required for the sub processing is a time required for executing each sub processing when a cache miss does not occur regarding measurement output values.

A rectangle including a shaded periphery, for instance, a rectangle of S173 indicates that prefetching for a sub processing with respect to a packet is being executed. A time required for the sub processing is a data access delay time when a cache miss occurs regarding measurement output values. Note that after optimization when the communication processing unit 20 issues a prefetch command, and prefetch is started, the communication processing unit 20 immediately proceeds to another packet processing. Specifically, the communication processing unit 20 concurrently proceeds another packet processing during a data access delay time, which is generated by prefetch.

In any of the rectangles, a required time is described within a bracket, and the width of a rectangle, specifically, the length in a time axis direction is illustrated in proportion to the required time.

Operation modification for optimizing processing of the communication processing unit 20 is the following two modifications relating to a sub processing with respect to a packet, in which a cache miss occurs and a data access delay time is generated:

The communication processing unit 20 issues a prefetch command with respect to data in which a cache miss occurs in the sub processing before the sub processing is executed; and

The communication processing unit 20 performs a sub processing with respect to another packet during prefetching.

For instance, a data access delay time when a cache miss occurs does not exist regarding key extraction (Step S103) and hash value calculation (Step S104). Therefore, it is possible to immediately start these processings regarding the packet 1 (Steps S171 and S172 in FIG. 13).

On the other hand, a data access delay time when a cache miss occurs exists regarding hash table search processing (Step S179 in FIG. 13). Therefore, after finishing Step S172, when a processor immediately starts Step S179, a cache miss may occur, and execution of the processor may be stopped during the data access delay time.

In view of the above, after finishing Step S172, a processor issues a prefetch command with respect to data to be used in Step S179, in which a cache miss occurs (Step S173). Then, the processor executes a sub processing with respect to a next packet (the packet 2, the packet 3) during prefetching.

In the example of FIG. 13, a processor performs key extraction and hash value calculation regarding the packet 2 and the packet 3 in Step S174 to Step S178. Hereinafter, as well as the aforementioned description, an operation of a processor of the communication processing unit 20 is modified to compensate for a data access delay by a sub processing with respect to another packet regarding a sub processing in which a data access delay time exists.

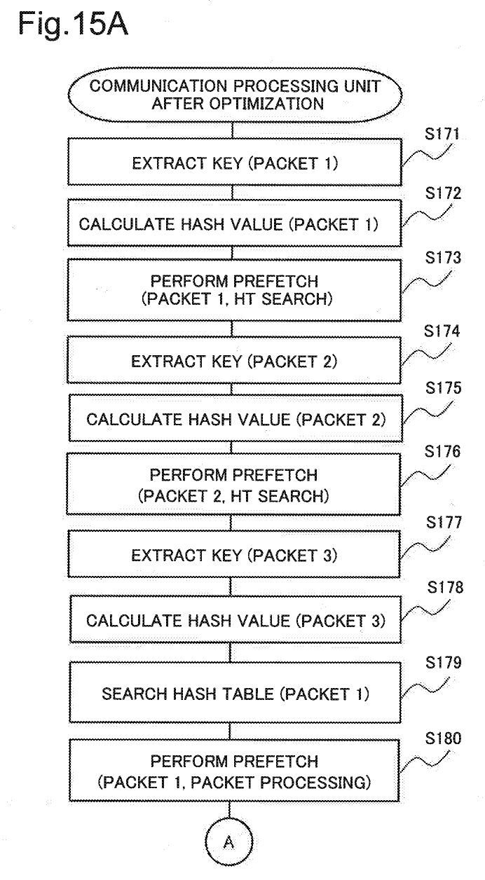

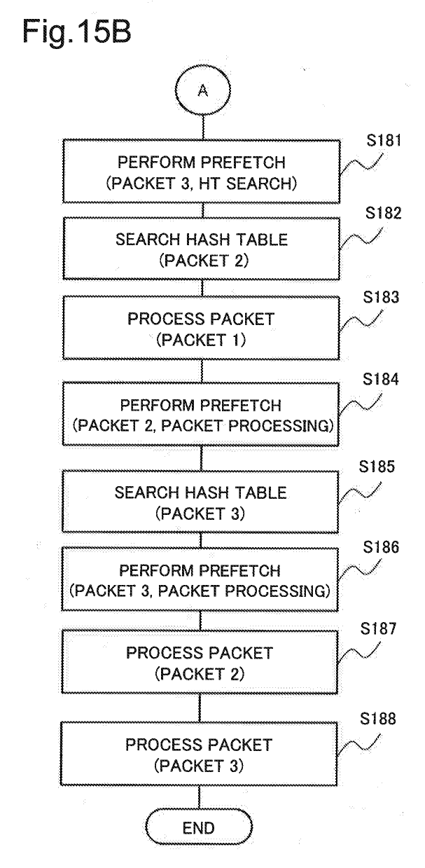

A packet processing operation of the communication processing unit 20 after optimization by the operation modification illustrated in FIG. 13 is described using FIG. 14, FIG. 15A, and FIG. 15B.

FIG. 14 is a flowchart illustrating an operation to be performed when the communication processing unit 20 after optimization receives a packet from the communication I/F unit 30 for processing. The operation may be started on an event-driven basis, or may be started by a polling operation by the communication processing unit 20.

The communication processing unit 20 receives a packet from the communication I/F unit 30 (Step S161).

The communication processing unit 20 confirms whether three or more unprocessed packets remain among received packets (Step S162). When three or more unprocessed packets remain (Y in Step S162), the communication processing unit 20 performs processing with respect to the first three packets (Step S163). The details will be described later.

When three or more unprocessed packets do not remain (N in Step S162), the communication processing unit 20 executes Step S103 to Step S107 described using FIG. 5 regarding each of the remaining unprocessed packets (Step S164).

FIG. 15A and FIG. 15B are flowcharts illustrating an operation of the communication processing unit 20 after optimization in Step S163.

The communication processing unit 20 extracts a key regarding the packet 1 (Step S171). The communication processing unit 20 calculates a hash value regarding a key of the packet 1 (Step S172). The communication processing unit 20 issues a prefetch command with respect to data to be used in hash table search regarding the packet 1 (Step S173).

The communication processing unit 20 extracts a key regarding the packet 2 (Step S174). The communication processing unit 20 calculates a hash value regarding a key of the packet 2 (Step S175). The communication processing unit 20 issues a prefetch command with respect to data to be used in hash table search regarding the packet 2 (Step S176).

The communication processing unit 20 extracts a key regarding the packet 3 (Step S177). The communication processing unit 20 calculates a hash value regarding a key of the packet 3 (Step S178). The communication processing unit 20 searches a hash table based on an obtained hash value regarding the packet 1, and retrieves a flow entry relating to a flow to which the packet belongs (Step S179).

The communication processing unit 20 issues a prefetch command with respect to data to be used in packet processing using a retrieved flow entry regarding the packet 1 (Step S180). The communication processing unit 20 issues a prefetch command with respect to data to be used in hash table search regarding the packet 3 (Step S181).

The communication processing unit 20 searches a hash table based on an obtained hash value regarding the packet 2, and retrieves a flow entry relating to a flow to which the packet belongs (Step S182).

When a flow entry with respect to the packet 1 is retrieved, the communication processing unit 20 processes the packet according to a processing method designated by the flow entry (Step S183). When a flow entry with respect to the packet is not retrieved, the communication processing unit 20 discards the packet.

The communication processing unit 20 issues a prefetch command with respect to data to be used in packet processing using a retrieved flow entry regarding the packet 2 (Step S184). The communication processing unit 20 searches a hash table based on an obtained hash value regarding the packet 3, and retrieves a flow entry relating to a flow to which the packet belongs (Step S185).

The communication processing unit 20 issues a prefetch command with respect to data to be used in packet processing using a retrieved flow entry regarding the packet 3 (Step S186). When a flow entry with respect to the packet 2 is retrieved, the communication processing unit 20 processes the packet according to a processing method designated by the flow entry (Step S187). When a flow entry with respect to the packet is not retrieved, the communication procession unit 20 discards the packet.

When a flow entry with respect to the packet 3 is retrieved, the communication processing unit 20 processes the packet according to a processing method designated by the flow entry (Step S188). When a flow entry with respect to the packet is not retrieved, the communication processing unit 20 discards the packet.

[Advantageous Effects]

The measuring apparatus 1 of the example embodiment is able to obtain a data access delay time when a cache miss occurs, and a time required for executing packet processing when a cache miss does not occur.

The first reason is that the measurement control unit 12 measures a time required for packet processing by the communication processing unit 20 for a plurality of flows under the control of the optimization control unit 11, and collects these measurement results.

Further, the second reason is that the optimization control unit 11 determines measurement output values based on a difference in a measurement result on a required time between a flow number range where a cache miss occurs, and a flow number range where a cache miss does not occur, from a measurement result group.

It is possible to optimize packet processing as executed by the communication processing unit 20 with use of a data access delay time when a cache miss occurs, and a time required for executing packet processing when a cache miss does not occur, which are output from the measuring apparatus 1 of the example embodiment. It is relatively easy to perform optimization when packet processing is implemented by a software component. However, optimization may be implementable also when packet processing is implemented by another means, for instance, by firmware or a logic circuit.

Further, a data access delay time when a cache miss occurs, and a time required for executing packet processing when a cache miss does not occur, which are output from the measuring apparatus 1, are also useful for another purpose such as designing a speed or a capacity of a cache memory of the communication processing unit 20, or the like.

### Modification of First Example Embodiment

The control unit 10 may not be necessarily separated into the optimization control unit 11 and the measurement control unit 12. The control unit 10 may be an integrated logic circuit, a dedicated processor, or a software module functioning as the optimization control unit 11 and the measurement control unit 12.

The communication processing unit 20 and the communication I/F unit 30 may not be necessarily included in the measuring apparatus 1. For instance, the communication processing unit 20 may exist in another device coupled to the measuring apparatus 1.

A cache miss flow threshold may be one value. The optimization control unit 11 may detect two local peaks from transition of a residual sum of squares associated with the number of flows illustrated in FIG. 11, and may set a median of the two flow numbers as a cache miss flow threshold. Alternatively, the optimization control unit 11 may detect one peak from transition of a residual sum of squares associated with the number of flows illustrated in FIG. 11, and may set a flow number at the peak as a cache miss flow threshold.

In these cases, the optimization control unit 11 may calculate a data access delay time when a cache miss occurs from a difference in a processing time for a flow number equivalent of the cache miss flow threshold ± a predetermined value (Step S152).

### Second Example Embodiment

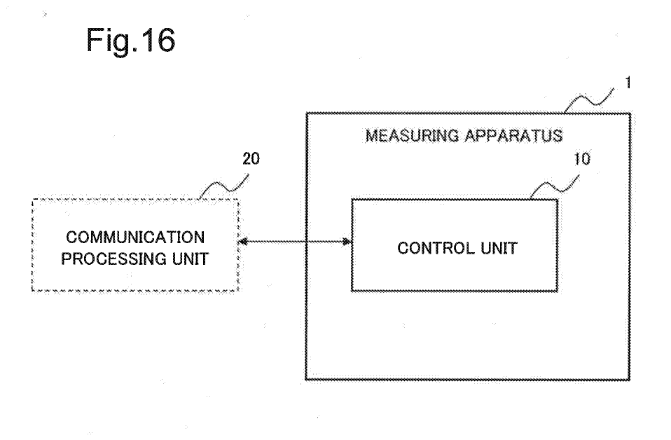

FIG. 16 is an explanatory diagram illustrating an example of a configuration of a measuring apparatus 1 according to the second example embodiment. The measuring apparatus 1 of the example embodiment includes a control unit 10 which measures a packet processing time of a communication processing unit 20 which performs packet processing of a communication flow with use of a cache memory for a plurality of communication flows; and calculates a packet processing time during the absence of a cache miss, and a processing delay time due to a cache miss from a measurement result.

The measuring apparatus 1 of the example embodiment is able to obtain a data access delay time when a cache miss occurs, and a time required for executing packet processing when a cache miss does not occur.

The reason for this is that the control unit 10 measures a time required for packet processing by the communication processing unit 20 for a plurality of flows, and collects these measurement results.

In the aforementioned description, the invention of the present application is described referring to the example embodiments. However, the invention of the present application is not limited to the aforementioned example embodiments. The configuration and the details of the invention of the present application may be modified in various ways comprehensible to a person skilled in the art within the scope of the invention of the present application.

This application is based upon and claims the benefit of priority from Japanese patent application No. 2014-206486, filed on Oct. 7, 2014, the disclosure of which is incorporated herein in its entirety by reference.

### REFERENCE SIGNS LIST

1 Measuring apparatus

2 Load generating device

3 Communication network

10 Control unit

11 Optimization control unit

12 Measurement control unit

20 Communication processing unit

30 Communication I/F unit

40 Load generating unit

50 Communication I/F unit

60 Measuring system

What is claimed is:

1. A measuring apparatus comprising:
a memory storing instructions; and
one or more processor configured to execute the instructions to:
measure a packet processing time of a communication processor that performs packet processing of a communication flow with use of a cache memory for a plurality of communication flows, and
calculate, from a measurement result, a packet processing time during which no cache miss occurs and a processing delay time due to a cache miss.

2. The measuring apparatus according to claim 1, wherein the one or more processor are further configured to execute the instructions to:
determine a threshold that is the number of communication flows separating presence or absence of cache miss occurrence based on a change in the packet processing time when the number of communication flows is increased, and
calculate the packet processing time during which no cache miss occurs and the processing delay time due to the cache miss based on a difference between a processing time with respect to the number of communication flows equal to or smaller than the threshold and a processing time with respect to the number of communication flows equal to or larger than the threshold.

3. The measuring apparatus according to claim 2, wherein the one or more processor are further configured to execute the instructions to:
calculate, based on a measurement result obtained for respective zones of the number of communication flows, an approximation formula of the number of communication flows and the packet processing time for each zone, and an error between the approximation formula and the measurement result being obtained by increasing the number of communication flows, and
determine the number of communication flows in a zone where the error peaks or in a zone where the error exceeds a predetermined threshold as the threshold.

4. The measuring apparatus according to claim 3, wherein the one or more processor are further configured to execute the instructions to:
determine a first threshold that is as the number of communication flows at which a processing delay due to a cache miss is started to occur based on a first local peak of the error,
determine a second threshold that is as the number of communication flows at which a processing delay is saturated based on a second local peak of the error, and
calculate the packet processing time during which no cache miss occurs, and the processing delay time due to the cache miss based on a difference between a processing time with respect to a number of communication flows equal to or smaller than the first threshold and a processing time with respect to a number of communication flows equal to or larger than the second threshold.

5. A measuring system comprising:
the measuring apparatus according to claim 1; and
a load generator that generates a communication load in accordance with the number of communication flows received, and transmits the communication load to the communication processor, wherein,
the communication processor outputs a packet processing time, and
the one or more processor are further configured to execute the instructions to:
select a number of communication flows, transmit the number of communication flows selected to the load generator, and receive a measurement result from the communication processing means.

6. A measuring method comprising:
measuring a packet processing time of communication processing means that performs packet processing of a communication flow with use of a cache memory for a plurality of communication flows; and
calculating, from a measurement result, the packet processing time during which no cache miss occurs and a processing delay time due to a cache miss.

7. The measuring method according to claim 6, further comprising:
determining a threshold that is the number of communication flows separating presence or absence of cache miss occurrence based on a change in the packet processing time when the number of communication flows is increased; and
calculating calculates the packet processing time during which no cache miss occurs and the processing delay time due to the cache miss based on a difference between a processing time with respect to the number of communication flows equal to or smaller than the threshold and a processing time with respect to the number of communication flows equal to or larger than the threshold.

8. The measuring method according to claim 7, further comprising:
calculating, based on a measurement result obtained for respective zones of the number of communication flows, an approximation formula of the number of communication flows and the packet processing time for each zone, and an error between the approximation formula and the measurement result being obtained by increasing the number of communication flows; and
determining the number of communication flows in a zone where the error peaks or in a zone where the error exceeds a predetermined threshold as the threshold.

9. The measuring method according to claim 8, further comprising:
determining a first threshold that is as the number of communication flows at which a processing delay due to a cache miss is started to occur based on a first local peak of the error;
determining a second threshold that is as a number of communication flows at which a processing delay is saturated based on a second local peak of the error; and
calculating a packet processing time during which no cache miss occurs and a processing delay time due to the cache miss based on a difference between a processing time with respect to a number of communication flows equal to or smaller than the first threshold and a processing time with respect to a number of communication flows equal to or larger than the second threshold.

10. A non-transitory computer-readable recording medium recording a program for causing a computer to execute measuring process, the measuring process comprising:
measuring a packet processing time of communication processing means that performs packet processing of a communication flow with use of a cache memory for a plurality of communication flows; and
calculating, from a measurement result, a packet processing time during which no cache miss occurs and a processing delay time due to a cache miss.
